(19) United States
(12) Patent Application Publication
(10) Pub. No.: US 2007/0291995 A1
(43) Pub. Date: Dec. 20, 2007

(54) System, Method, and Apparatus for Preventing Identity Fraud Associated With Payment and Identity Cards

(76) Inventor: Paul G. Rivera, Seffner, FL (US)

Correspondence Address: HOLLAND & KNIGHT LLP;ATTN: STEFAN V. STEIN/ IP DEPT., POST OFFICE BOX 1288, TAMPA, FL, 33601-1288, US

(21) Appl. No.: 11/760,320

(22) Filed: Jun. 8, 2007

Related U.S. Application Data
(63) Continuation-in-part of application No. 11/450,522, filed on Jun. 9, 2006.

(51) Int. Cl. G06K 9/00

(52) U.S. Cl. 382/115

(57) ABSTRACT

The system, method, and apparatus of the present invention, address the problem of identity theft associated with the use of payment cards such as credit and debit cards, as well as identity theft associated with the use of identity cards such as driver's licenses and social security cards. An apparatus including a biometric input component that authenticates a system user is disclosed herein. Upon authentication, a proxy account number and a time varying security code are generated and displayed on the apparatus. The dynamically generated number and security code are then used to validate the user's identity within the system. Furthermore, the system, method, and apparatus of the present invention can be used to consolidate into one instrument, several payment and identity instruments.

### CROSS-REFERENCE TO RELATED INVENTIONS

This is a continuation-in-part of U.S. patent application Ser. No. 11/450,522, filed Jun. 9, 2006, the disclosure of which is hereby incorporated by reference herein.

### BACKGROUND OF THE INVENTION

1. Field of the Invention

The present invention relates to a transaction processing system and method and more particularly pertains to conducting business electronically in a secure and convenient manner.

2. Description of the Background Art

Consumers today are intimately familiar with carrying credit cards and other small cards containing personal information. In fact, this has led to wallet glut, where people's purses and wallets are overflowing with credit cards, driver's licenses, retail store cards, ATM cards, health insurance cards, etc. This phenomenon has created a number of problems. First, with every new card, people must make additional room in their purses or wallets to carry this item. The consumer who carries only a billfold is left to decide between which cards he will carry on any particular occasion. Second, the more cards circulating, the greater the chance for the criminal element to inappropriately acquire another's card and do harm. Recent waves of identity theft are certain indicators demonstrating this situation.

It is well known that the proliferation of identity fraud is a direct result of increased technology cheaply marketed to the public. Such technology is used by identity thieves to create counterfeit identification instruments such as cloned credit cards, forged Social Security cards, bogus driver's licenses, and so forth. In fact, a counterfeit copy can be made of most identity instruments that contain static information. Unfortunately, it is the associative set of static information contained by these instruments which modern society uses to concretely identify an individual, and it is this associative set of static information, exposed each time an identity instrument is presented, that creates the very opportunity for an identity thief to practice his craft. With each exposition of an individual's identity instruments, that individual increases their chances of becoming a victim of identity fraud.

Furthermore, the evolution of the internet, and its wide use by the public, has served to further exacerbate the problem. As an example, bank customers led to a web site imitating their bank's web site casually submit to the fraudulent site account numbers, passwords, and other personal information, usually without any awareness afterward that they have just been scammed by what is commonly known as phishing. In another example, shoppers are directed to a mock copy of a popular merchant's web site and submit credit card information, believing themselves to be purchasing an item from a trusted merchant.

Traditional methods for securing identity instruments from misuse include secret passwords, pass phrases, and pin numbers; all of which are themselves susceptible to theft as a result of also being static. Prior art methods of computer and internet security also fail to prevent identity fraud. As one example, U.S. Pat. No. 6,000,832 to Franklin relates to an electronic online commerce card with customer generated transaction proxy number for online transactions; while Franklin accomplishes its goal, it is still susceptible to theft of an individual's identity by way of phishing.

The use of business systems is known in the prior art. More specifically, business systems previously devised and utilized for the purpose of conducting business electronically are known to consist basically of familiar, expected, and obvious structural configurations, notwithstanding the myriad of designs encompassed by the crowded prior art which has been developed for the fulfillment of countless objectives and requirements.

By way of example, U.S. Pat. No. 6,038,315 issued Mar. 14, 2000 to Strait relates to a Method and System for Normalizing Biometric Variations to Authenticate Users from a Public Data Base and That Ensures Individual Biometric Data Privacy. In addition, U.S. Pat. No. 6,182,076 issued Jan. 30, 2001 to Yu relates to a Web-based, Biometric Authentication System and Method. Further, U.S. Pat. No. 6,580,814 issued Jun. 17, 2003 to Ittycheriah relates to a System and Method for Compressing Biometric Models. Lastly, U.S. Patent Application Publication Number 2002/0056043 issued May 9, 2002 to Glass relates to a Method and Apparatus for Securely Transmitting and Authenticating Biometric Data over a Network.

While these devices fulfill their respective, particular objectives and requirements, the aforementioned patents do not describe a transaction processing system that allows conducting business electronically in a secure and convenient manner.

In this respect, the transaction processing system according to the present invention substantially departs from the conventional concepts and designs of the prior art, and in doing so provides an apparatus primarily developed for the purpose of conducting business electronically in a secure and convenient manner.

Therefore, it can be appreciated that there exists a continuing need for a new and improved transaction processing system which can be used for conducting business electronically in a secure and convenient manner. In this regard, the present invention substantially fulfills this need.

Thus, what is needed is a system, method and apparatus for preventing identify fraud associated with payment and identity cards. This system, method and apparatus must also include the ability to reduce the number of cards in circulation, thereby striking at the heart of the identity thefts' occupation. The system, method and apparatus disclosed herein provides a number of security measures to prevent theft and otherwise protect valuable personal information.

While each of the above systems and methods accomplish their individual objectives, what is still lacking is a single system for securely carrying all of a users needed data cards. As disclosed below, an objective of the present system is to allow users to confidently carry all personal data cards with enhanced security measures.

Therefore, it is an object of this invention to provide an improvement which overcomes the aforementioned inadequacies of the prior art devices and provides an improvement which is a significant contribution to the advancement of the identify fraud prevention art.

An additional object of the present invention is to insure that all personally identifying or harmful information is stored at a trusted, centralized facility, such as an issuing bank, so that even if an identify theft steals a personal data card of this invention, the card will be useless to the thief.

An additional object of the present invention is to secure the personal data card directly on the card through biometric security measures.

The foregoing has outlined some of the pertinent objects of the invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

In view of the foregoing disadvantages inherent in the known types of business systems now present in the prior art, the present invention provides an improved transaction processing system. As such, the general purpose of the present invention, which will be described subsequently in greater detail, is to provide a new and improved transaction processing system and method which has all the advantages or the prior art and none of the disadvantages.

To attain this, the present invention essentially comprises a transaction processing system for conducting business electronically in a secure and convenient manner. The system includes a card sub-system including a fingerprint scanner and a Hash value “A” generator coupled to the fingerprint scanner with a comparator coupled to the generator for comparing fingerprint data from the generator to a fingerprint value “0” in a data base. The card sub-system also includes an unequal gate coupled to the comparator and a negative display unit coupled to the unequal gate for displaying a service denial message when the Hash value “A” does not equal the fingerprint value “0”. The card sub-system also includes an equal gate and a parametric equation “P” component coupled to the equal gate and an encryption component coupled to the parametric equation “P” component and a positive display unit coupled to the encryption component for displaying a service acknowledgement message when the Hash value “A” equals the fingerprint value “0” and for transmitting a new card number “N”. The card sub-system has a storage component for initial fingerprint data.

The system also comprises a transaction sub-system including a point of sales terminal and a telephone operator terminal and a secure web page terminal. Each of the terminals is adapted to receive data transmitted from the positive display unit of the card sub-system. The transaction sub-system also includes a transaction data “T” transfer component coupled to the point of sales terminal. The transaction sub-system also includes a transaction data “T” manual entry component coupled to the telephone operator terminal. The transaction sub-system also includes a transaction data “T” submission component coupled to both the secure web page terminal and the manual entry component.

Further, the system comprises a server sub-system including an application server with a decryption component coupled to the application server and a deriver component coupled to the decryption component and retrieve component coupled to the deriver component. The application server is adapted to receive transaction data “T” from the submission component and the retrieve component is adapted to transmit transaction data “T” and account information “I”. The application server has a storage component for initial fingerprint data.

Lastly, the system comprises an electronic financial transaction, EFT, network sub-system including a retransfer component for receiving transaction data “T” from the transaction data “T” transfer component and delivering it to the application server. The EFT network sub-system also includes a delivery component for receiving transaction data “T” and account information “I” from the retriever component.

The invention also includes the method of providing the system as described above and the steps of manipulating and transmitting data within and between the sub-systems.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims attached.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

In its most basic form of the invention, a user has a smart card that does not visually reveal an account number or ID information of the cardholder. Furthermore, the card includes a fingerprint sensor and a display unit. The fingerprint sensor on the card allows access to the card's functions; using biometrics, only the authorized cardholder will be allowed said access. The card's main function is to dynamically generate proxy account numbers according to a certain set of criteria, and to also generate a time varying pin number according to a similar set of criteria. The card's display unit then shows the newly generated account number and pin. In a preferred embodiment, each newly generated account number can only be used once. This ensures that theft of an account number will have no value to identity thieves. Furthermore, the newly generated pin number ensures that theft of the pin number is also rendered valueless to a thief, unless the theft occurs at the same time that the pin will be used; an unlikely scenario given that most pin theft occurrences happen during a network intrusion event, and are not used until many hours, or even days, after the event.

The card may further include a Radio Frequency Identification (“RFID”) component for communication with traditional payment terminals at merchant sites.

In another embodiment, a user has a mobile device that includes a fingerprint sensor and a display unit, and is used in the same manner as the smart card recited above. Furthermore, the card may also have user pressable keys for selecting from several accounts, thus allowing the single card to store a plurality of data cards.

In any form of the invention, the system provides security against theft of personal information found on: credit cards, debit cards, driver's licenses, passports, visas, social security cards, other government issued identification cards, employment identification cards, birth certificates, and other security certificates and documents.

It is therefore an object of the present invention to provide a new and improved transaction processing system and method which have all of the advantages of the prior art business systems and none of the disadvantages.

It is another object of the present invention to provide a new and improved transaction processing system and method which may be easily and efficiently manufactured and marketed.

It is further object of the present invention to provide a new and improved transaction processing system which is of durable and reliable constructions.

An even further object of the present invention is to provide a new and improved transaction processing system which is susceptible of a low cost of manufacture with regard to both materials and labor, and which accordingly is then susceptible of low prices of sale to the consuming public, thereby making such transaction processing system economically available to the public.

Even still another object of the present invention is to provide a transaction processing system and method for conducting business electronically in a secure and convenient manner.

Lastly, it is an object of the present invention to provide a transaction processing system and method. The system includes a card sub-system having a negative display unit and a positive display unit and means for transmitting transaction data. The system also includes a transaction sub-system having terminals adapted to receive transaction data transmitted from the card sub-system. The system also includes a server sub-system adapted to receive transaction data from the transaction sub-system and adapted to transmit transaction data and account information. The system further includes an EFT network sub-system for receiving transaction data from the transaction sub-system and delivering it to the application server and for receiving transaction data and account information from the server sub-system. The method includes the manipulation and transfer of data within and between the sub-systems.

These together with other objects of the invention, along with the various features of novelty which characterize the invention, are pointed out with particularity in the claims annexed to and forming a part of this disclosure.

For a better understanding of the invention, its operating advantages and the specific objects attained by its uses, reference should be had to the accompanying drawings and descriptive manner in which there is illustrated preferred embodiments of the invention.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The invention will be better understood and objects other than those set forth above will become apparent when consideration is given to the following detailed description thereof. Such description makes reference to the annexed drawings which include schematic illustrations of embodiments of a transaction processing system and method constructed in accordance with the principles of the present invention.

FIG. 1 is a flow chart illustrating a first embodiment of the present invention.

FIG. 2 is a flow chart illustrating an enrollment phase of the present invention.

FIG. 3 is a flow chart illustrating an alternative enrollment phase of the present invention wherein a user associates a plurality of identification instruments with the card of the present invention.

FIG. 4 is a flow chart illustrating a usage phase of the present invention.

FIG. 5 is a flow chart illustrating an alternative usage phase of the present invention wherein the user uses a card storing a plurality of identification instruments.

FIG. 6 is a flow chart illustrating a financial transaction system using four different terminal sub-systems.

FIG. 7 is a depiction of a preferred embodiment of the card pursuant to the present invention.

FIG. 8 is a flow chart illustrating an alternative embodiment of the invention whereby two users complete a financial transaction utilizing two mobile devices practicing the invention.

Similar reference characters refer to similar parts throughout the several views of the drawings.

### DETAILED DESCRIPTION OF THE INVENTION

The present invention, the transaction processing system and method is comprised of a plurality of components and steps. Such components in their broadest context include a card sub-system, periodically referred to herein as the Multicard, a transaction sub-system, and a server sub-system. Such steps include the manipulation and transmission of data within and between the sub-systems. Such components are individually configured and correlated with respect to each other so as to attain the desired objective.

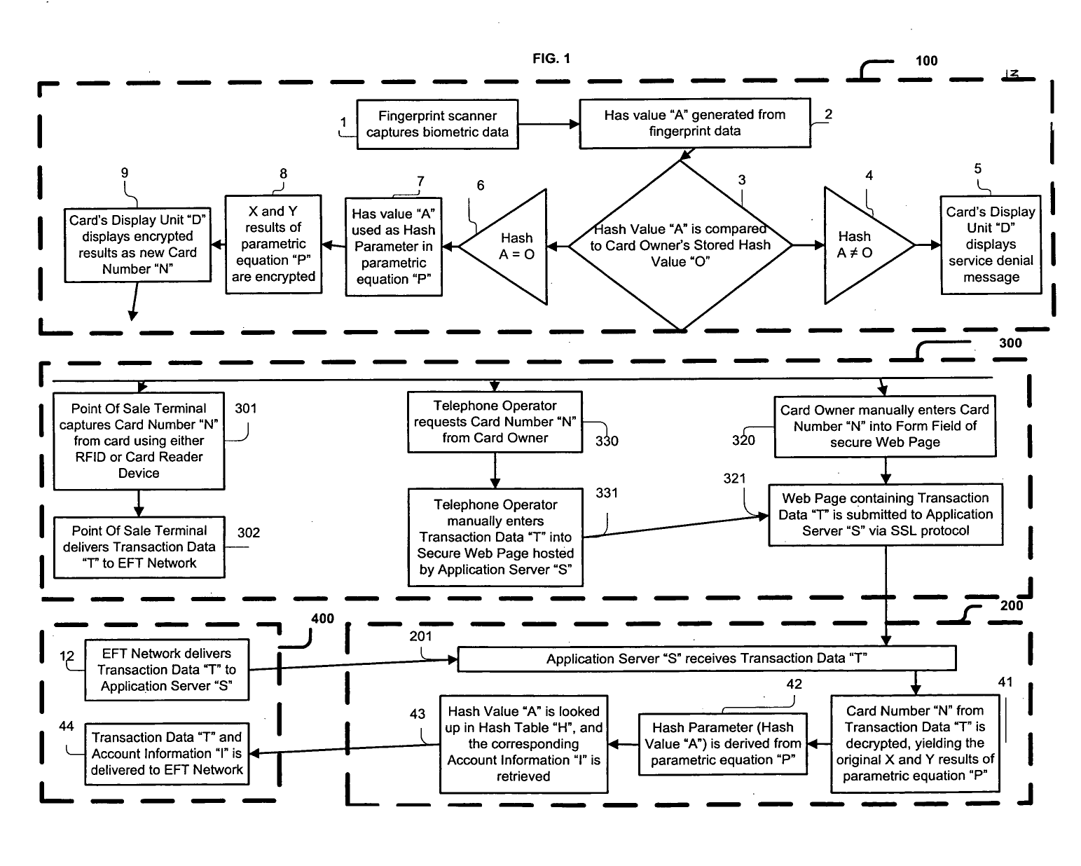

With reference now to FIG. 1, an embodiment of the new and improved transaction processing system embodying the principles and concepts of the present invention.

More specifically, the system of the present invention includes a transaction processing system for conducting business electronically in a secure and convenient manner. The system comprises, in combination, a card sub-system 100 including a fingerprint scanner 1 and a Hash value “A” generator 2 coupled to the fingerprint scanner. A comparator 3 is coupled to the generator for comparing fingerprint data from the generator to a fingerprint value “0” in a data base. The card sub-system also includes an unequal gate 4 coupled to the comparator and a negative display unit 5 coupled to the unequal gate for displaying a service denial message when the Hash value “A” does not equal the fingerprint value “0”. The card sub-system also includes an equal gate 6 and a parametric equation “P” component 7 coupled to the equal gate and an encryption component 8 coupled to the parametric equation “P” component and a positive display unit 9 coupled to the encryption component for displaying a service acknowledgment message when the Hash value “A” equals the fingerprint value “0” and for transmitting a new card number “N”. The card sub-system has a storage component for initial fingerprint data.

The system also comprises a transaction sub-system 300 including a point of sales terminal 301 and a telephone operator terminal 330 and a secure web page terminal 320. Each of the terminals is adapted to receive data transmitted from the positive display unit of the card sub-system. The transaction sub-system also includes a transaction data “T” transfer component 302 coupled to the point of sales terminal. The transaction sub-system also includes a transaction data “T” manual entry component 331 coupled to the telephone operator terminal. The transaction sub-system also includes a transaction data “T” submission component 321 coupled to both the secure web page terminal and the manual entry component.

Further, the system comprises a server sub-system 200 including an application server 201 with a decryption component 41 coupled to the application server and a deriver component 42 coupled to the decryption component and a retrieve component 43 coupled to the deriver component. The application server is adapted to receive transaction data “T” from the submission component and the retrieve component adapted to transmit transaction data “T” and account information “I”. The application server has a storage component for initial fingerprint data.

Lastly, the system comprises an electronic financial transaction EFT network sub-system 400 including a transfer component 12 for receiving transaction data “T” from the transaction data “T” transfer component and delivering it to the application server. The EFT network sub-system also includes a delivery component 44 for receiving transaction data “T” and account information “I” from the retrieve component.

The method of the present invention includes the steps of providing the apparatus as described above and the further step of manipulating and transferring data within and between the sub-stations. More specifically, the steps include first scanning the fingerprint of a card holder prior to any financial transaction for providing base initial fingerprint data for storing in both the card sub-system and the application server followed by supplemental scans of a fingerprint of a card holder which take place with each subsequent financial transaction. The steps also include generating a new card number in the card sub-system 100 if the scanned fingerprint of a user corresponds to a base fingerprint in the data base of the system, transferring the new card information from the positive display unit 9 to the transaction sub-system 300, transferring data from the submission component 321 to the application server 201 and from the transfer component of the transaction sub-component to the retransfer component 12 of the EFT network sub-system then to the application server 201, and transferring data from the retriever component 43 to the delivery component 44.

The preferred apparatus for utilizing the system of the present invention is a smart card consisting of a microprocessor with integrated memory, an electronic paper display unit, and an embedded fingerprint scanner 1. When such an apparatus is employed in the system of the present invention, a card holder can initiate and conduct an electronic financial transaction by passing his or her finger over the fingerprint scanner. A first scan is prior to any financial transaction for providing base fingerprint data into both the card sub-system and the application server. Supplemental scans of a fingerprint of a card holder takes place with each subsequent financial transaction. FIG. 1 schematically illustrates the entire process which the system uses to conduct the electronic financial transaction once the card holder has passed a finger over the scanner. The embedded fingerprint scanner 1 on the card creates a digital template which the microprocessor on the card sub-system 100 uses to input a generator 2, to generate a hash value hereafter referenced as hash value “A”.

It should be noted that the very first time the card holder passes a finger over this device there is no financial transaction. As described below, this first use constitutes an enrollment phase for activation of the card. The system and process differs from prior systems and processes in that there is no financial transaction taking place during such first scan. Instead, hash value “A” and the card holder's account information, hereafter referenced as account information “I”, are added to the system's hash table, hereafter referenced as hash table “H”. This is a table in a database residing on the system's application server sub-system 102, which includes the application server “S”. Also, hash value “A” is permanently stored in the memory of the card subsystem 100. The hash value that is stored during this first fingerprint scan is hereafter referenced as hash value “0”.

During subsequent scans, presumably performed at the moment just before the card holder is about to conduct an electronic financial transaction, the microprocessor on the card sub-system 100 compares the stored hash value “0” with hash value “A” which is generated by the generator 2 and compared by comparator 3. This occurs each time for a financial transaction after a fingerprint scan by scanner 2. If the two hash values are not equal as determined by an unequal gate 4, then the card sub-system microprocessor will send a “service denied” message to be displayed by the electronic paper on the card's surface, hereafter referenced as the negative display unit “D”, and the process ends there.

If the two hash values are equal as determined by the equal gate 6, then hash value “A” is used as the hash parameter in a parametric equation component 7, hereafter referenced as parametric equation “P”. The resulting X and Y values are then encrypted by the microprocessor encryption component 8 and displayed on positive display unit “D” 9 as an encrypted string of alphanumeric characters. This string of characters is hereafter referenced as the card's new card number “N”

At present, it is considered that any one of many terminal device types in the transaction sub-system 300 can complete the transaction by accepting the new card number “N”. The first terminal is any device equipped with either radio frequency identification, RFID, technology if the card is a contactless card, or a card reader device if the card is a contact card. An example of such a device may be a merchant's point of sale terminal 301. A second terminal includes a telephone operator at an operator terminal 330 that is signed on to a secure web session hosted by application server “S” 331. An automated telephone system with secure access to application server “S” may request the card number. At a third terminal, the card holder manually enters their new card number “N” onto a transactional web page at a submission terminal 320.

In the first case, the device transmits to the EFT Network 302, the transaction data which includes card number “N”, and hereafter referenced as transaction data “T”. The EFT Network sub-system 400 then delivers transaction data “T” to application server “S” 12. In the other two cases, transaction data “T” is submitted directly to application server “S” submission component 321 using the secure sockets layer protocol.

In all cases, once application server 201 “S” receives transaction data “T”, the card number “N” is taken from transaction “T” and decrypted to obtain the original X and Y values resulting from parametric equation “P” component 41. Using the original X and Y values, the second parameter, application server “S” can derive the hash parameter, hash value “A”, from parameter equation “P” via deriver component 42 and use it, the hash value “A”, to query hash table “H” and retrieve the account information “I” via deriver component 43. Application server “S” then sends transaction data “T”, replacing the encrypted X and Y values with account information “I”, to an EFT network sub-system complete the financial transaction via delivery component 44.

As to the manner of usage and operation of the present invention, the same should be apparent from the above description. Accordingly, no further discussion relating to the manner of usage and operation will be provided.

Further detail is now provided concerning numerous other features of the present invention. More specifically, the system of the present invention includes two main phases. The first phase is an enrollment step wherein a user enrolls with an issuing institution, such as a bank, practicing the system and method of the current invention. As described in detail below, this enrollment phase serves to initialize all pertinent data stored by the various sub-systems in order to provide upmost identify theft and other fraud protection. During this enrollment phase, the card sub-system and server sub-systems are programmed so as to authenticate the end-user and associate the end-user's account information appropriately.

Once the enrollment phase is completed, the usage phase of the invention begins. During this usage phase, the end-user uses the card Multicard in a similar fashion to current uses of credit cards, debit cards, drivers licenses, social security cards, etc. Of course, this usage is done in a substantially more secure manner than that of the current art, providing needed levels of identify theft prevention to end-users. What follows below is a more detailed description of these two primary phases including descriptions of the preferred embodiments of apparatus to practice this invention.

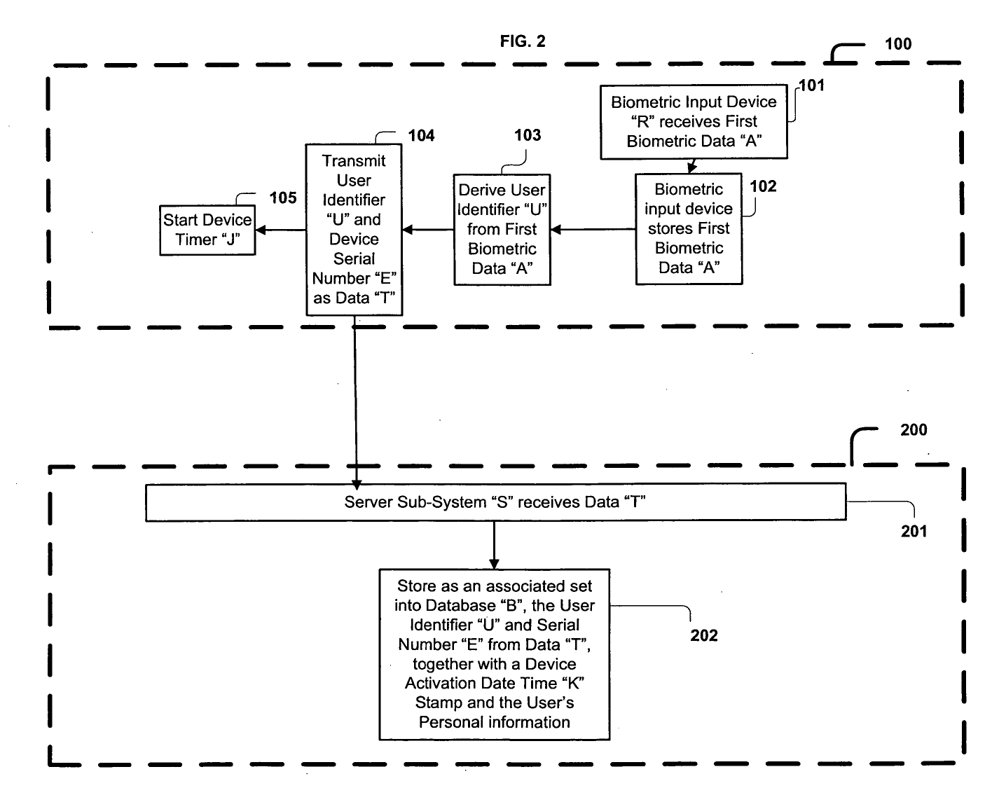

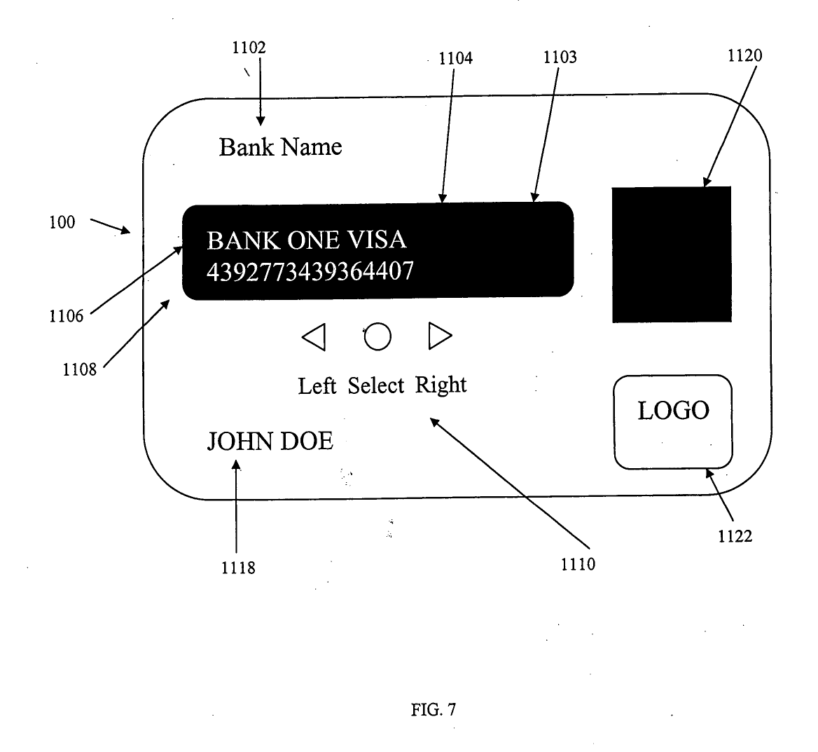

FIG. 2 is a flow chart diagram depicting the enrollment and activation of the Multicard 100 and the application server 103 practicing this invention. To aid in understanding this invention, it is worthwhile to review FIG. 7, which depicts a preferred embodiment of a credit-card-styled Multicard 100, which will be discussed in detail below. Prior to enrollment, Multicard 100 is uninitialized and unusable. To activate the Multicard 100, the user must first provide a biometric sample A, such as a fingerprint, to the Multicard. While the discussion herein uses the example of a fingerprint as the preferred biometric sample, the use of any biometric sample, such as a retina scan, a hair follicle analysis, palm print, or other such sample would be obvious to one skilled in the art and is thus within the scope of the current invention. At step 101, the user provides his biometric sample using the biometric input device R on the Multicard 100. In the case of fingerprint, the user would pass his finger over the biometric input device R.

As depicted in step 102, the biometric input device R records a representation of the user's biometric sample A. This biometric sample A is then stored within a storage medium on the Multicard 100. This storage medium could be any known storage medium including RAM, ROM, EEPROM, or any other storage media. By programming the Multicard 100 with this initial biometric sample A, the Multicard 100 is essentially tied to the user such that only that user's biometric sample will match with this biometric sample A stored within the device. While this is a preferred embodiment, it is obvious to one skilled in the art that the Multicard 100 could be configured so as to recognize multiple biometric samples and store the mappings between many of them, allowing all members of a family, for instance, to share the same Multicard 100.

Step 103 depicts the creation of a user identifier U, based upon the biometric sample A stored previously. In step 104, user identifier U is combined with a device serial number E programmatically so as to produce a data member T. As can be seen in FIG. 2, this data member T is transmitted to the application server sub-system 200. Finally, in step 105, a device timer J is started on the Multicard 100. This can be accomplished through a number of means, including recording the current point in time, such as recording the number of seconds elapsed since the Unix epoch, which was midnight Coordinated Universal Time of Jan. 1, 1970, not counting leap seconds. Of course, this is merely an exemplary way of starting device timer J.

At this stage, the Multicard 100 has completed the enrollment phase, but the server sub-system 200 still needs to be initialized. Initialization of the server sub-system 200 begins when it receives the data member T from the Multicard 100 as shown in step 201. The data member T can be transmitted to the server sub-system 200 through any number of transmission means including TCP/IP, WIFI, RFID, or any other mechanisms. Once server subsystem 200 receives data member T, the server 200 extracts the user identifier U and the device serial number E from the data member T and stores this information in a data store, such as database B. As further shown in step 202, server 200 also stores the current activation time K in the database B. As is obvious to one skilled in the art, the clock generating the timestamp J on the Multicard 100 must be approximately in sync or adjusted appropriately to correspond with the clock utilized by the server 200.

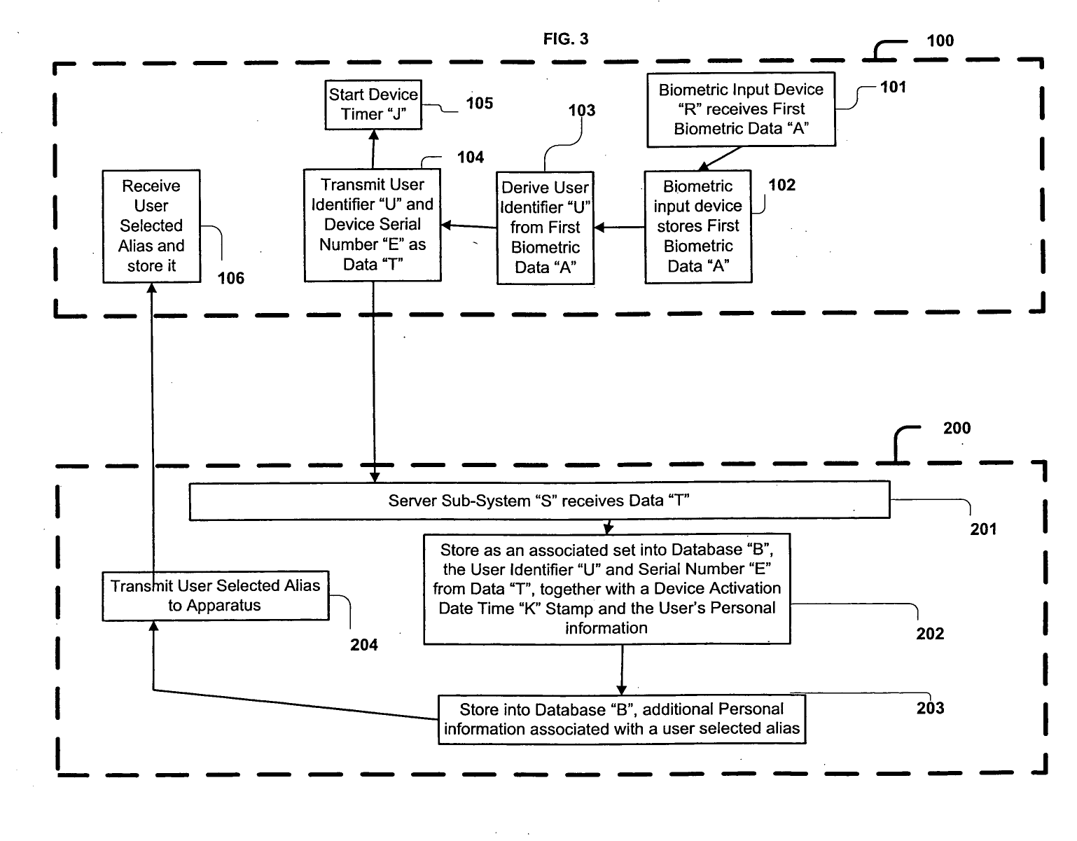

Now, the Multicard 100 has been enrolled and is activated and ready for use. What must still be done, however, is associating the Multicard 100 with at least one credit card, debit card, social security card, government identification card, or any other type of card. As shown in FIG. 3, this is accomplished through step 203. The issuing institution collects from the user information from the card sought to be stored in the Multicard 100, and stores this information within a datastore utilized by the server 200, such as database B, by associating this information with a user selected alias. Finally, this alias is transmitted back to the Multicard 100 for storage on the Multicard 100 as shown in step 106. An example of this stage of the process would proceed as follows. The user, wishing to associate his American Express card with his Multicard would, after enrollment, provide the issuing institution with his American Express account information. This can be accomplished through a number of ways, including swiping the magnetic strip of the American Express card at a bank facility or otherwise. Similarly, the user could provide this information over the internet or telephone to an authorized representative of the issuing institution. The user would also provide an alias to use for this account, such as “American Express Card.” It is this alias that will display on the Multicard 100, as depicted in FIG. 7. Thus, at this stage, the Multicard 100 only stores the alias “American Express Card,” while all the sensitive financial information, including the actual American Express account number, are stored securely by the issuing institution practicing this invention.

What follows next is a description of the usage stage of this invention. This stage, as mentioned above, follows enrollment and describes how the Multicard 100 of the present system is utilized to provide enhanced security, while still integrating with the current Electronic Funds Transfer networks already in existence.

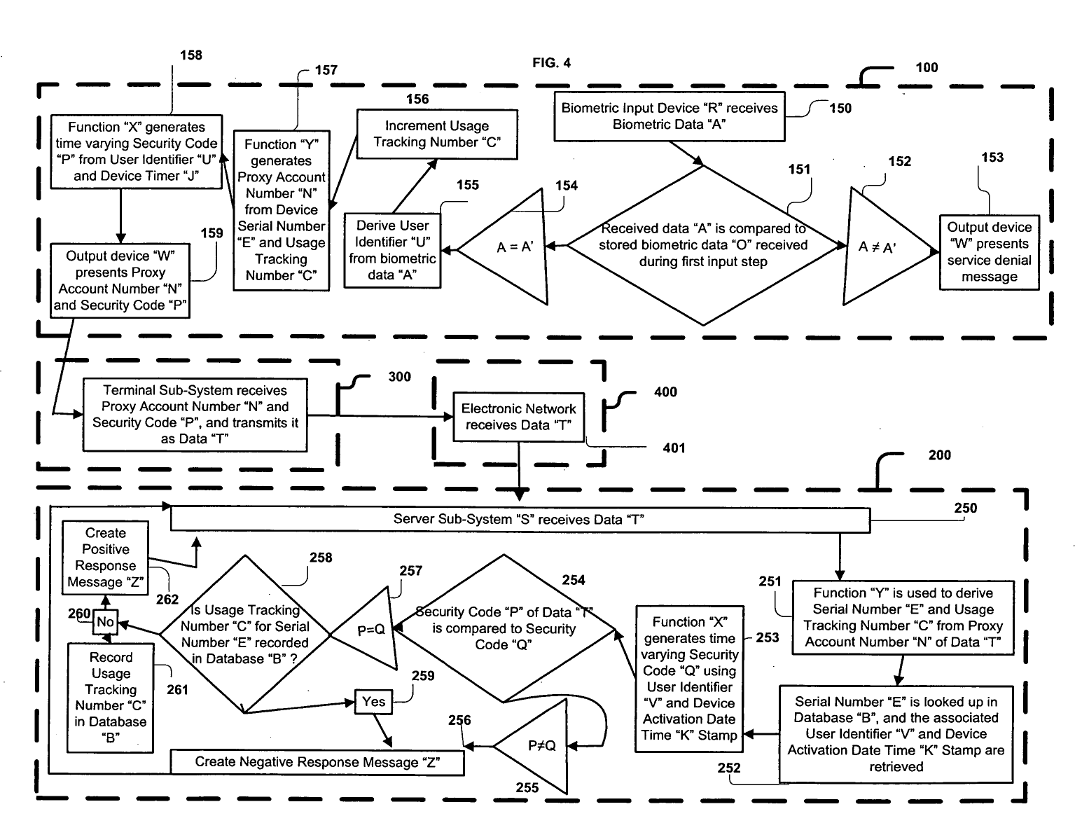

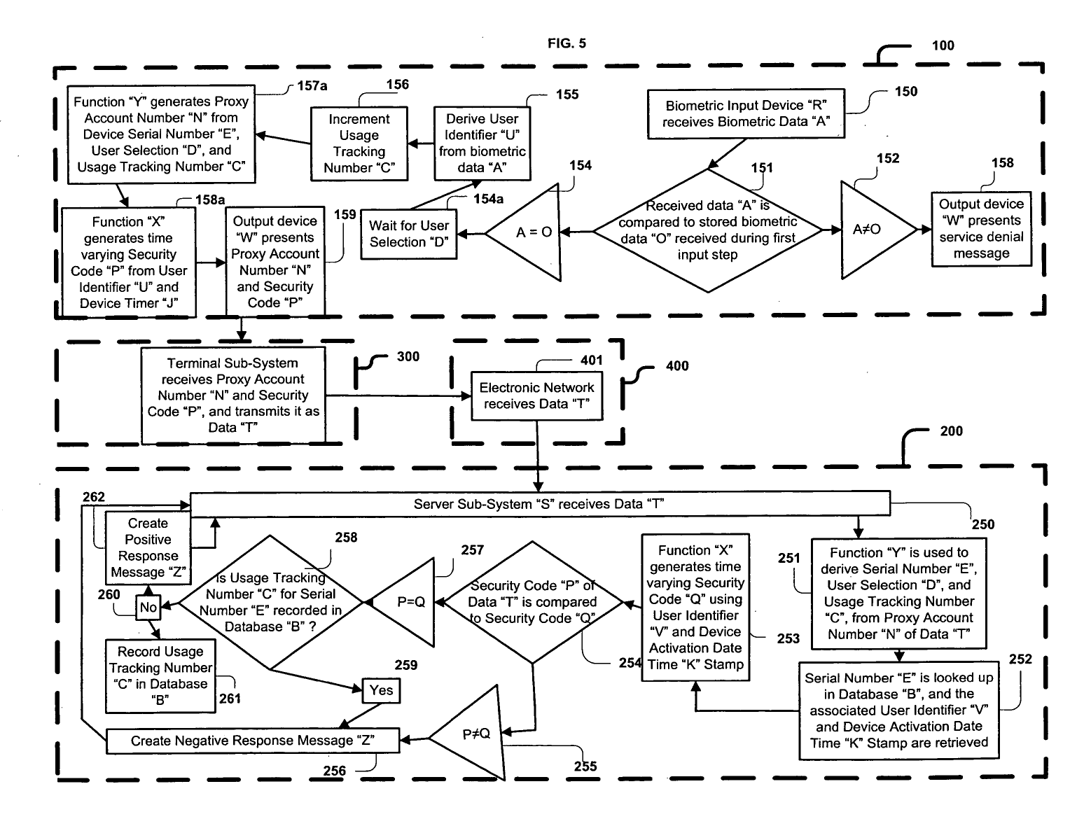

FIGS. 4 and 5 describe flow charts of the usage of the invention of the present system. In this situation, Multicard 100 is first utilized to authenticate the individual physically holding the Multicard 100 by comparing that individual's biometric sample with the biometric sample stored on the Multicard 100. As during the enrollment phase, the holder of the card presents a biometric sample A′ to the Multicard 100. This biometric sample A′ can be a fingerprint, hair sample, palm print, retina scan, or any other biometric sample, as collected above during the enrollment phase. This biometric sample A′ is then compared with the biometric sample A stored on the MultiCard 100. If the biometric sample A′ offered by the cardholder does not match the biometric sample A stored on the Multicard 100, the Multicard displays a service denial message as shown at step 153. This step serves to deactivate the card thus preventing thieves, or any other unauthorized users, from accessing and using the Multicard 100.

If the cardholder's biometric sample A′ does match the stored biometric sample A, as shown in step 154, the Multicard 100 moves to an activated stage, where a proxy account number N will be generated and used by the merchant. Steps 155 through 159 depict the generation of the proxy account number and are discussed below. This proxy account number is a standard ISO 7812 number. As is known, the maximum length of an ISO 7812 number is nineteen digits and ISO 7812 account numbers are standardly used by numerous cards including credit cards, debit cards, ATM cards, etc.

An ISO 7812 number contains a single digit major industry identifier, a six digit issuer identifier number, an account number and a single digit check sum. The first six digits including the major industry identifier compose the issuer identifier number. This identifies the issuing organization. The last number of the ISO 7812 number is a check sum. This check sum is calculated using the Luhn algorithm and is used to validate the rest of the identification number.

In the preferred embodiment of this invention, all nineteen digits of the ISO 7812 number are used. As is obvious to one skilled in the art however, the invention can be practiced utilizing less than the full nineteen digits of the ISO 7812 number. The discussion that follows however uses the full nineteen digits. The first six digits, as mentioned above, are the issuer identifier identifying the issuing organization. The next twelve digits, combined with the final check sum digit, represent the part of the proxy account number N that changes with each transaction, as discussed in detail below.

As shown in steps 155 through 159, the proxy account number N is computed as a function of the Multicard's 100 device serial number E and a transaction number C. As shown in FIG. 5, when the Multicard 100 is configured to store a plurality of underlying cards, an additional step 154a exists allowing the user time to select the appropriate account by selecting one of the aliases previously stored in the card. Returning to FIG. 4, the Multicard 100 first derives the user identifier from the biometric data A stored on the card 100. Next, the Multicard 100 increments a usage tracking number C. This usage tracking number can be any regularly changing piece of information, but is preferably implemented as an incrementing unsigned integer. Next, as shown in step 157, the Multicard 100 uses the device serial number E and the usage tracking number C to compute a proxy account number N.

As is familiar to most users of ATM and debit cards, many issuing institutions require an additional personal identification number, also known as a PIN, in order to authenticate a card. Optional steps 158 and 159 describe an additional layer of security for issuing institutions that require a PIN be used. Thus, if the card being accessed by the user does not need a PIN for authentication, steps 158 and 159 are not necessary. However, if the card does require a PIN, steps 158 and 159 provide enhanced security. In step 158, the user identifier U is programmatically combined with the device timer J to result in a time varying security code P. This time varying security code P is used in place of the user's PIN normally associated with the subject card, as will become more clear in discussion below. Finally, at step 159, the proxy account number N and optional time varying security code P are presented to a payment terminal 300. To this end, the Multicard 100 can be configured with contacts (not shown) to connect to a network and communicate with the server sub-system 200. Similarly, the proxy account number N and security code can be read from the Multicard 100's display 1104 and entered into any point of sale terminal, web page, or other device configured to accept such information.

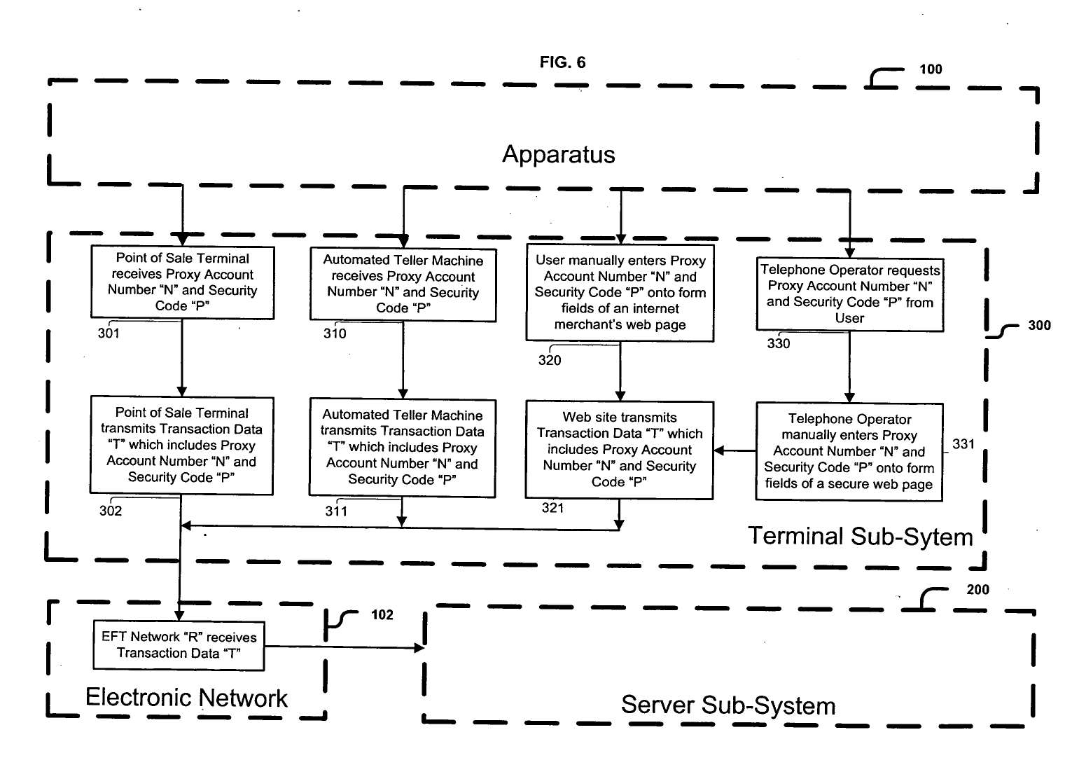

As shown in FIG. 6, payment terminal 300 can be any number of payment accepting terminal, such as a point of sale device terminal 301, an Automated Teller Machine 310, an internet webpage 320 or a telephone operator 330. As is obvious to one skilled in the art, the examples depicted in FIG. 6 are merely exemplary and a number of alternatives exist which are within the scope of the current invention. As shown in each of steps 302, 311, 321 and 331, once any payment terminal 300 receives the proxy account number N and optional security code P, it simply transmits this information to existing electronic networks 400 utilized for processing payment transactions.

Returning to FIGS. 4 and 5, the proxy account number N and optional security code P, which have been combined as a tuple and identified in the diagrams as data T, are transmitted into electronic payment networks 400. As the proxy account number N is a standard ISO 7812 number, the electronic network parses out the initial digits which serve to inform the electronic network which issuing institution is responsible for authenticating this transaction. Because the initial digits identify the issuing institution practicing this invention, and thus running server 200, the data tuple T is routed to the server 200 as shown at step 250.

Server 200 then extracts the serial number E and tracking number C from the proxy account number N at step 251. As shown in FIG. 5, the extraction at step 250a includes a third element in this tuple, which corresponds to the user's selection D from step 154a. This selection D is used by the server 200 to determine which of the plurality of cards stored for the user are intended to be used in the instant transaction. Next, at step 252, the server 200 retrieves the appropriate device activation time stamp K from its database B. Using this retrieved timestamp K, server 200 performs the same function performed at step 158 on the Multicard 100 to generate a time varying security code Q. This server generated security code Q is compared with the security code P offered during the transaction. If these two codes do not match, or are not within a predetermined variance based on differences in time, the server rejects the transaction, as shown in steps 254 through 256. Not depicted in this flow chart is the transmission back to the terminal 300 indicating the payment attempt was not authenticated.

When the security code Q does satisfy the necessary requirements, as depicted in step 257, the server 200 moves to its next authentication check to verify the usage tracking number C provided by the user has not previously been used. If the usage tracking number C has already been used, the server 200 rejects the transaction as shown in steps 258 and 259. Otherwise, the usage tracking number C is stored by the server 200 at step 261 and a positive response is prepared. Not depicted in FIGS. 3 and 4 is the next step, wherein the server 200 transmits the users actual account information on the electronic network 400 so that the appropriate institution can authenticate or reject the transaction. Using the example from above, if the server 200 made it to step 262, the server 200 would then extract the user's American Express account information from its datastore, and transmit this information to the electronic network 400. American Express, would then receive the transaction information and authenticate or reject the transaction.

FIG. 7 depicts a preferred embodiment of the Multicard 100 of the present invention. In FIG. 7, the Multicard 100 is sized so as to be approximately equivalent in dimensions to credit card and other personal identification cards currently known in the art. This enables the Multicard 100 to seamlessly replace current credit cards in user's purses and wallets. As can be seen from FIG. 7, Multicard 100 includes a location for the issuing bank or institution to display its name 1102. Similarly, Multicard 100 includes an area in which the issuing bank or institution can display any other insignia 1122. Multicard 100 also includes an area for displaying the account holder's name 1118.

Important inventive features of Multicard 100 are the display 1104, the biometric input device 1120 and the buttons 1110. When the user attempts to use the Multicard 100 first he must authenticate the card using the biometric input device 1120. In the embodiment depicted in FIG. 7, the biometric input device 1120 accepts fingerprints, but as is obvious to one skilled in the art, this biometric input device could recognize any biometric sample. When the user presses his or her fingerprint to the biometric fingerprint device 1120 the Multicard 100 detects whether or not the biometric features of the user's fingers match those stored on the card. If the biometric features of the user's finger match what is stored permanently on the card then the card is authenticated. If the biometric features do not match the card, the card remains inactive. Whether or not the card is active is displayed on the display 1104. For instance, in one embodiment (not depicted), when the Multicard 100 is not authenticated or is inactive, the display 1104 could read “DO NOT USE” or some other similar indication As such, no proxy account number will be displayed by the Multicard 100, and thus no transactions can begin without first authenticating the user through the biometric sensor 1120. As depicted in FIG. 7 however, the display 1104 is currently active and is displaying the account holder John Doe's account Bank One Visa with the proxy account number N listed at 1108.

After the user authenticates himself, he is then presented with the option of choosing which account to use that is stored in Multicard 100. To do so, the user utilizes buttons 1110. While the embodiment depicted in FIG. 7 lists only three buttons 1110, it would be obvious to use any number of buttons or other control elements to allow the user to choose the appropriate account stored within Multicard 100.

As an additional security measure, the account number 1108 displayed on the card and used at the point of sale is not the customer's actual account number with his or her credit card, debit card, or other card. Instead, the account number 1108 is a proxy account number N, as discussed above.

Another example is provided to aid in understanding this invention. Using FIG. 7, the account name 1106 Bank One Visa will correspond to the account holder 1118 John Doe's first account stored in the Multicard 100. In an embodiment where the Multicard 100 stores various account aliases in an indexed array, the Bank One Visa account could correspond to an index zero of the indexed array. The proxy account number N, displayed at 1108 on Multicard 100 is generated from Multicard 100's serial number E, an incrementing transaction number C and the index zero as Bank One Visa corresponds to index element zero in John Doe's account array. When John Doe uses this card, existing point-of-sale terminals simply process the card as any other card entering the digits displayed as the proxy account number N, displayed at 1108.

As discussed above, the proxy account number N is then sent to the application server 200 associated with the present invention. This application server then applies the reverse formula converting the proxy number back into its respective serial number, transaction number and index. It is important to note at this stage in the transaction, the user John Doe's actual credit card account number has still not been revealed to any parties. Using the index, the application server determines which of John Doe's actual accounts are to be used. In this case, John Doe's Bank One Visa. The application server then performs the authentication steps described in FIGS. 4 and 5.

Through this method, only the issuing institution that runs the application server 200 is aware of John Doe's credit card number. Thus, would-be thieves would not have access to this actual number and their attempts to steal the same would be thwarted. The next time user John Doe attempted to use his Bank One Visa card, the usage tracking number would be different, preferably incremented by the number one. Thus, the second time he uses his Bank One Visa, the transaction number two will be used generating an entirely different proxy account number N. When the application server receives this proxy account number and decodes it into its respective parts, it will determine that it is checking transaction number two for John Doe's account with Bank One Visa.

As described above, there are a number of inventive security measures embodied in the present invention. Initially, prior to receiving access to any information whatsoever a would-be thief would need to somehow activate the biometric sensor 1120 and convince the card that the would-be thief is the owner of the card. As a second layer of security, the card only generates proxy account numbers N and thus the account number has limited usage, if any, for potential thieves. This is because once a proxy account number N has been used once, it is then rendered entirely useless.

As an additional security mechanism, as described above, many issuing organizations such as banks require a second level of security by of a PIN. Users today are quite familiar with memorizing a four digit PIN in order to activate their debit cards. The preferred embodiment of the present invention also includes a time based security code P, providing additional anti-theft protection. This time based security code P would be displayed on the Multicard 100 preferably in location 1103. As shown in FIG. 7, location 1103 is currently blank, and thus the account selected does not utilize this security feature. If the selected account did require a PIN, then location 1103 would include a security code P pursuant to the current invention.

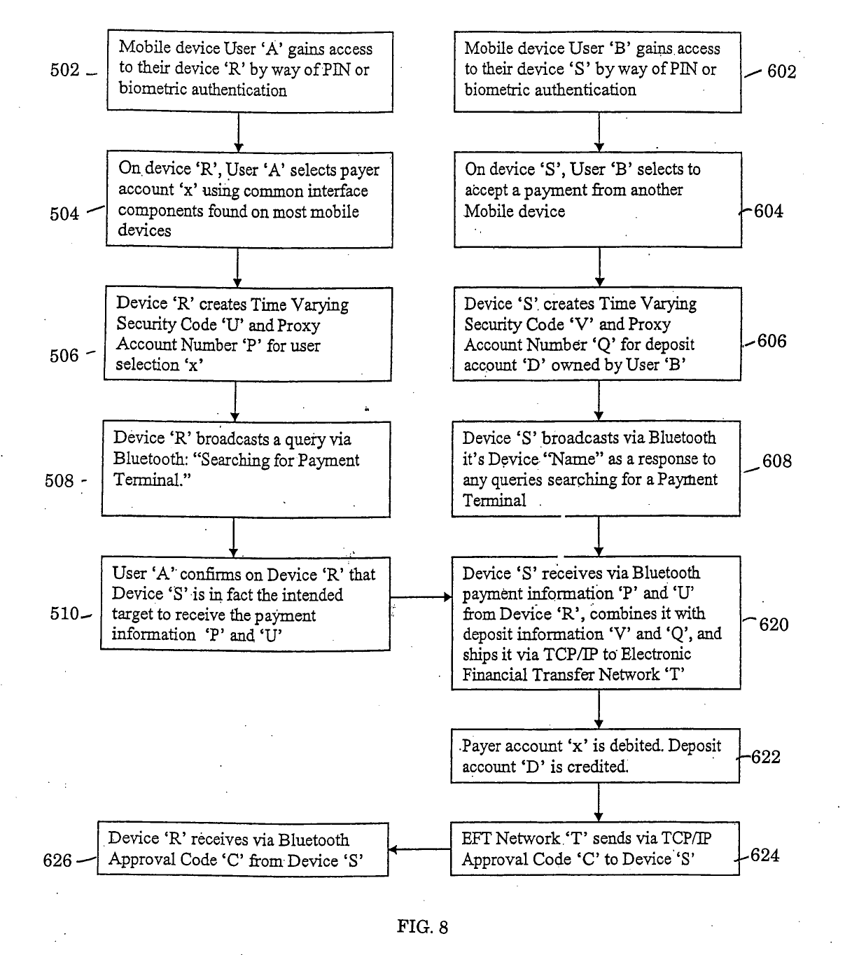

FIG. 8 depicts an example transaction utilizing the present invention to perform a financial transaction between two users “A” and “B”. An example of such a transaction would be user A purchasing an item from user B at user B's garage sale. Instead of exchanging paper money, user A purchases the goods or services as follows.

User A carries device “R” which contains an embodiment of the present invention. Device R could be any number of devices, including a mobile phone, a personal digital assistant, a smart watch, or otherwise. Using device R, user A authenticates herself to the device, preferably using a biometric sample, as seen at step 502. Once authenticated, device R enables user A to select an appropriate account to use for the transaction at step 504. This selection process allows user A to select one of the account aliases she has previously set up in configuring device R.

Following the teachings of the current invention, at step 506, device R generates a proxy account number P and a time varying security code U for the account selected by user A. The time varying security code ensure that the transaction will only be acceptable within a certain period of time; thus, if someone attempts to authenticate this transaction outside of the window of time allowed for this transaction to be valid, the attempted authentication will fail, providing enhanced security.

At step 508, device R uses communication technology to look for user B's device. As shown in step 508, broadcasting a query via Bluetooth is one possible way to implement this feature.

Meanwhile, user B has also been configuring her device to accept payment from user A's device. First, in step 602, user B authenticates herself to her device S, preferably through biometric means. Next, at 604, user B instructs the device to accept payment from another device. Further practicing this invention, at step 606, device S creates a proxy account number Q and a time varying security code V for user B's deposit account D. Thus, access to user B's deposit account is protected by the same mechanisms described in this invention.

Next, as seen in step 608, user B's device S responds to user A's broadcast request and user B's device S identifies itself as a payment terminal. At step 510, user A verifies that the device identified is the intended device, and if so, transmits her proxy account number P and security code U to user B's device. User B's device then receives this information and combines the proxy account number P and security code U with the proxy account number Q and security code V corresponding to user B's deposit account D. Device S then transfers this information to existing EFT networks for processing.

As described above, at step 622, the EFT network will process this transaction, and appropriately debit user A's account “x” and credit user B's deposit account D. Device S then receives an approval code (or rejection code) “C” from the EFT network at step 624. Finally, at step 626, device S sends this approval or rejection code C to user A's device R, completing the transaction.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

It is also to be realized that numerous steps were described in a particular sequence. As is obvious to one skilled in the art, however, the sequence described is useful for explanation but does not limit the order in which certain steps must be taken.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. A transaction processing system comprising:
a card sub-system comprising:
a biometric input sensor;
a data storage component;
a proxy account number generator;
a data transmitter;
a display unit; and
a server sub-system adapted to receive the proxy account number transmitted from the card sub-system after the biometric input sensor authenticates a user whereby the server sub-system determines an actual identification number based upon the proxy account number.

2. The system of claim 1 whereby the biometric input sensor detects fingerprints.

3. The system of claim 1 whereby the biometric input sensor detects retina measurements.

4. The system of claim 1 whereby the biometric input sensor detects voice patterns.

5. The system of claim 1 whereby the card sub-system further comprises:
a device serial number; and
a usage tracking number; such that the proxy account number generator programmatically generates a proxy account number utilizing the device serial number and the usage tracking number.

6. The system of claim 5 whereby the usage tracking number is an incrementing number.

7. The system of claim 1 whereby the card sub-system further comprises:
a user identifier;
a device timer; and
a security-code generator whereby the security-code generator programmatically generates a security code utilizing the user identifier and the device timer.

8. The system of claim 1 whereby the proxy account number is an ISO 7812 number.

9. The system of claim 1 whereby the card sub-system further comprises:
a user alias selector; and
the server sub-system is further configured to receive a user alias selected by the user such that the user alias is programmatically used with the proxy account number to determine an actual identification number.

10. The system of claim 9 whereby the user alias selector is comprised of buttons.

11. The system of claim 1 whereby the actual identification number is a credit card number.

12. The system of claim 1 whereby the actual identification number is a debit card number.

13. The system of claim 1 whereby the actual identification number is a social security number.

14. The system of claim 1 whereby the card sub-system is a smart card.

15. The system of claim 1 whereby the card sub-system is a telephone.

16. The system of claim 1 whereby the card sub-system is a personal digital assistant.

17. The system of claim 1 further comprising
an enrollment phase whereby a user activates the card sub-system by presenting a biometric sample to the biometric input sensor, whereupon the card sub-system stores the biometric sample in the data storage component; and
a usage phase whereby a user activates the biometric sensor generating a per-use biometric sample and the card sub-system compares the per-use biometric sample with the biometric sample stored in the data storage component activating the card sub-system when the per-use biometric sample corresponds to the biometric sample stored in the data storage component and deactivating the card sub-system when the per-use biometric sample does not correspond to the biometric sample stored in the data storage component.

18. An identification card device comprising:
a biometric input sensor;
a data storage component;
a proxy account number generator;
a data transmitter; and
a display unit; whereby the card receives a biometric sample from the biometric input sensor and compares the biometric sample with a previously received biometric sample stored in the data storage component, the card further displaying on the display unit a proxy account number generated by the proxy account number generator when the biometric sample corresponds to the previously received biometric sample stored in the data storage component and transmitting the proxy account number through the data transmitter.

19. The card of claim 18 whereby the biometric input sensor detects fingerprints.

20. The card of claim 18 whereby the biometric input sensor detects retina measurements.

21. The card of claim 18 whereby the biometric input sensor detects voice patterns.

22. The card of claim 18 further comprising:
a device serial number; and
a usage tracking number; such that the proxy account umber generator programmatically generates a proxy account number utilizing the device serial number and the usage tracking number.

23. The card of claim 22 whereby the usage tracking number is an incrementing number.

24. The card of claim 18 further comprising:
a user identifier;
a device timer; and
a security-code generator whereby the security-code generator programmatically generates a security code utilizing the user identifier and the device timer.

25. The card of claim 18 whereby the proxy account number generated by the proxy account number generator is an ISO 7812 number.

26. The card of claim 18 further comprising:
a user alias selector, whereby a user of the card utilizes the user alias selector to select an alias.

27. The card of claim 26 whereby the user alias selector is comprised of buttons.

28. The card of claim 18 whereby the proxy account number corresponds to a credit card number.

29. The card of claim 18 whereby the proxy account number corresponds to a debit card number.

30. The card of claim 18 whereby the proxy account number corresponds to a social security number.

31. The card of claim 18 further comprising:
an enrollment phase whereby a user activates the card by presenting a biometric sample to the biometric input sensor, whereupon the card stores the biometric sample in the data storage component; and
a usage phase whereby a user activates the biometric sensor generating a per-use biometric sample and the card sub-system compares the per-use biometric sample with the biometric sample stored in the data storage component activating the card when the per-use biometric sample corresponds to the biometric sample stored in the data storage component and deactivating the card when the per-use biometric sample does not correspond to the biometric sample stored in the data storage component.

32. The card of claim 18 whereby the card is a smart card.

33. The card of claim 18 whereby the card is a telephone.

34. The card of claim 18 whereby the card sub is a personal digital assistant.

35. A first machine readable medium having stored thereon a set of instructions, which when executed cause a system to perform a method comprising:
a card sub-system comprising:
a biometric input sensor;
a data storage component;
a proxy account number generator;
a data transmitter;
a display unit; and
a second machine readable medium having stored thereon a set of instructions, which when executed cause a system to perform a method comprising
a server sub-system adapted to receive the proxy account number transmitted from the card sub-system after the biometric input sensor authenticates a user whereby the server sub-system determines an actual identification number based upon the proxy account number.

36. The first machine readable medium claim 35 whereby the biometric input sensor detects fingerprints.

37. The first machine readable medium of claim 35 whereby the biometric input sensor detects retina measurements.

38. The first machine readable medium of claim 35 whereby the biometric input sensor detects voice patterns.

39. The first machine readable medium of claim 35 whereby the card sub-system further comprises:
a device serial number; and
a usage tracking number; such that the proxy account number generator programmatically generates a proxy account number utilizing the device serial number and the usage tracking number.

40. The first machine readable medium of claim 39 whereby the usage tracking number is an incrementing number.

41. The first machine readable medium of claim 35 whereby the card sub-system further comprises:
a user identifier;
a device timer; and
a security-code generator whereby the security-code generator programmatically generates a security code utilizing the user identifier and the device timer.

42. The first machine readable medium of claim 35 whereby the proxy account number is an ISO 7812 number.

43. The first machine readable medium of claim 35 whereby the card sub-system further comprises:
a user alias selector; and
the server sub-system of the second machine readable medium is further configured to receive a user alias selected by the user such that the user alias is programmatically used with the proxy account number to determine an actual identification number.

44. The first machine readable medium of claim 43 whereby the user alias selector is comprised of buttons.

45. The second machine readable medium of claim 35 whereby the actual identification number is a credit card number.

46. The second machine readable medium of claim 35 whereby the actual identification number is a debit card number.

47. The second machine readable medium of claim 35 whereby the actual identification number is a social security number.

48. The first machine readable medium of claim 35 further comprising
an enrollment phase whereby a user activates the card sub-system by presenting a biometric sample to the biometric input sensor, whereupon the card sub-system stores the biometric sample in the data storage component; and
a usage phase whereby a user activates the biometric sensor generating a per-use biometric sample and the card sub-system compares the per-use biometric sample with the biometric sample stored in the data storage component activating the card sub-system when the per-use biometric sample corresponds to the biometric sample stored in the data storage component and deactivating the card sub-system when the per-use biometric sample does not correspond to the biometric sample stored in the data storage component.

49. The first machine readable medium of claim 35 whereby the card sub-system is implemented on a smart card.

50. The first machine readable medium of claim 35 whereby the card sub-system is implemented on a telephone.

51. The first machine readable medium of claim 35 whereby the card sub-system is implemented on a personal digital assistant.
